(19) United States
(12) Patent Application Publication
(10) Pub. No.: US 2026/0316993 A1
(43) Pub. Date: Oct. 15, 2026

(54) A CONTAINER

(71) Applicant: CRESCENT INDUSTRIAL LTD, Leamington Spa (GB)

(72) Inventors: Stephen John STACEY, Leamington Spa (GB); Thomas Karl STACEY, Leamington Spa (GB); Jonathan Bruce STACEY, Leamington Spa (GB); Daniel Lloyd STACEY, Leamington Spa (GB); Alfred James STACEY, Leamington Spa (GB); Calvin Luke STACEY, Leamington Spa (GB)

(73) Assignee: CRESCENT INDUSTRIAL LTD, Leamington Spa (GB)

(21) Appl. No.: 19/481,053

(22) PCT Filed: Apr. 30, 2024
(86) PCT No.: PCT/GB2024/051147

§ 371 Date: Nov. 3, 2025

(30) Foreign Application Priority Data
May 9, 2023 (GB) 2306805.9

(51) Int. Cl. B65D 5/60

(52) U.S. Cl. CPC B65D 5/60

(57) ABSTRACT

A container (100). The container (100) comprises: container walls and a container floor forming a bag-retaining surface, the container walls also forming a rim; and at least one bag retainer (112) attached to the bag-retaining surface, each bag retainer being configured to retain a respective portion of a bag (108).

### FIELD OF THE INVENTION

The present invention relates to a container. More particularly, the present invention relates to a container or bin for use with sweepers used for cleaning surfaces dirtied with potentially hazardous waste.

### BACKGROUND TO THE INVENTION

For the cleaning of outdoor and indoor surfaces, sweeper machines, such as motor sweepers, have been widely used for some time. Motor sweepers may comprise at least a frame supporting a sweeping brush, and a rear or front collection bin for receiving waste collected by the sweeping brush.

Use of a sweeper machine in environments with potentially hazardous waste or debris may often expose the user to hazardous or harmful particles. For example, the use of a sweeper machine in construction environments may expose the user to hazardous dust particles known as respirable crystalline silica (RCS). Heavy and prolonged exposure to RCS can cause severe respiratory damage, and may lead to respiratory health issues such as silicosis, lung disease, lung cancer, and other serious respiratory diseases.

Existing sweeper machines may allow plumes of the potentially hazardous dust back into the environment following the emptying of the hopper or bin or container of the sweeper machine. For example, a user may decant the contents of the hopper or bin into a designated waste bin, which may release at least some of the potentially hazardous dust into the environment to be subsequently inhaled by the user or others close by.

The present invention has been devised to mitigate at least some of the above-mentioned problems.

### SUMMARY OF THE INVENTION

In accordance with a first aspect of the present invention, there is provided a bag retainer for attachment to a bag-retaining surface of a container, the bag retainer comprising: a cavity having a bag-receiving aperture configured to receive a respective portion of a bag.

Preferably, the bag retainer comprises a resiliently flexible portion attached to a rim of the bag-receiving aperture.

Preferably, the resiliently flexible portion comprises one or more resiliently flexible tabs.

Preferably, the bag retainer comprises an adhesive backing.

In accordance with a second aspect of the present invention, there is provided a container comprising: container walls and a container floor forming a bag-retaining surface, the container walls also forming a rim; and at least one bag retainer attached to the bag-retaining surface, each bag retainer being configured to retain a respective portion of a bag.

The ‘bag-retaining surface’ may be understood as a surface of the container adapted to be at least partially covered by the bag in use.

The ‘rim’ may be understood as a portion of the container formed by the container walls over which an opening of the bag may be folded in use. The rim may be formed by upper and side edges of the side walls.

The container may comprise any suitable material. For example, the container material may be polyethylene. The container may be transparent, translucent, or opaque. The container may be of any suitable size. For example, the container may comprise a height of 38 centimetres, a width of 82 cm, and a length of 142 cm.

The bag may be any non-rigid container appropriately sized for use with the container or bin of the present invention. Preferably, an opening of the bag is sized such that at least a portion of the opening is foldable over at least a portion of the rim. For example, the bag may comprise a height of 91 centimetres, a width of 82 cm, and a length of 142 cm. The bag may comprise any suitable material, for example polythene. The bag may be transparent, translucent, or opaque.

The present invention may advantageously provide a means for easily attaching a bag to the container. The present invention may also advantageously provide a means for easily removing the bag from the container after collection of potentially hazardous waste or debris from an environment such as an indoor or outdoor surface of, for example, a construction site. Advantageously, removal of the bag from the container may be safer than existing containers or bins used with sweeper machines because the bag may be closed and sealed prior to removal from the bin to facilitate containment of the potentially hazardous waste or debris. In particular, the bag can be sealed after use and prior to disposal using, for example, a cable tie for closing the opening of the bag.

The at least one bag retainer may advantageously provide a means for preventing the bag from being removed from the container during use when there is no debris to weigh the bag down. In particular, a bag retainer retains a respective portion of the bag (for example a portion of the bag material), and may prevent the bag from being removed from the container via this portion of the bag. This may provide particular utility when a vacuum component proximate the container is activated, because the at least one bag retainer may prevent the bag from being sucked into the vacuum component.

Preferably, the at least one bag retainer each comprises a cavity having a bag-receiving aperture configured to receive the respective portion of the bag. The cavity may advantageously provide a volume for receiving and retaining the respective portion of the bag. A larger cavity may advantageously increase a volume of the respective portion of the bag retained by the bag retainer, which may in turn advantageously increase the retaining force of the bag retainer.

Preferably, the at least one bag retainer each comprises a resiliently flexible portion attached to a rim of the bag-receiving aperture. The resiliently flexible portion preferably provides minimal resistance along a first direction into the cavity, and provides substantial resistance along a second direction out of the cavity. In this way, a portion of the bag may easily be inserted into the cavity. A substantially greater force may be required to remove the portion of the bag from the cavity. Therefore, the resiliently flexible portion may advantageously provide a means for easily inserting the portion of the bag into the respective bag-receiving aperture, whilst preventing the portion of the bag from escaping the bag-receiving aperture, for example when a vacuum is activated.

Preferably, the resiliently flexible portion comprises one or more resiliently flexible tabs. Preferably, the tabs are configured to provide minimal resistance along a first direction into the cavity, and provide substantial resistance along a second direction out of the cavity. In this way, a portion of the bag may easily be inserted into the cavity. A substantially greater force may be required to remove the portion of the bag from the cavity. Therefore, the resiliently flexible tabs may advantageously provide a means for easily inserting the portion of the bag into the respective bag-receiving aperture, whilst preventing the portion of the bag from escaping the bag-receiving aperture, for example when a vacuum is activated.

In some embodiments, the at least one bag retainer is detachable from the bag-retaining surface of the container. Advantageously, the at least one bag retainer may be easily affixed to existing containers. Alternatively, the at least one bag retainer is affixed to the bag-retaining surface. Further alternatively, the at least one bag retainer and the bag-retaining surface are manufactured as a unified unit.

Preferably, the at least one bag retainer comprises an adhesive backing. Advantageously, the bag retainers may be easily attached and/or removed from the container.

Preferably, the container walls comprise: a first side wall; a second side wall opposing the first side wall; and a back wall connecting the first and second side walls. In this way, an opening of the container may be formed by at least a partially missing front wall and at least a partially missing roof. Advantageously, the bag may be more easily attached to the container. Further advantageously, the bag may more easily receive potentially hazardous waste or debris.

Preferably, the at least one bag retainer comprises a first pair of bag retainers positioned on opposing side walls of the container. Advantageously, the first pair of bag retainers may at least partially prevent the bag from bunching up, billowing out or deforming in some way to hinder capture of waste during use. Further advantageously, the first pair of bag retainers may prevent the bag from being removed from the container during use.

Preferably, the at least one bag retainer comprises a second pair of bag retainers positioned on opposing side walls of the container at different positions to the first pair of bag retainers. Advantageously, the second pair of bag retainers may further prevent the bag from bunching up during use. Further advantageously, the second pair of bag retainers may prevent the bag from being removed from the container during use.

Preferably, the first pair of bag retainers are positioned proximate a first corner of the respective side walls and the second pair of bag retainers are positioned proximate a second corner of the respective side walls. In this way, each pair of bag retainers may be positioned at different corners of the side walls. Advantageously, such positioning may further prevent the bag from bunching up during use. Further advantageously, such positioning may prevent the bag from being removed from the container during use.

Preferably, the first corner is an upper back corner, and the second corner is a lower front corner. Advantageously, such positioning may further prevent the bag from bunching up, billowing out or deforming in some way to hinder capture of waste during use. Further advantageously, such positioning may maximise a useable volume of the bag for collection of waste, and minimise a restriction to the entrance of the container.

Preferably, the floor comprises at least one floor bag retainer. In this way, the bag may be prevented from detaching from the floor portion of the bag retaining surface. Advantageously, the bag may be further prevented from bunching up during use. Further advantageously, the at least one floor bag retainer may prevent the bag from being removed from the container during use.

Preferably, the at least one floor bag retainer comprises a pair of floor bag retainers located proximate different corners of the floor. In this way, the positioning of the floor bag retainers at different corners of the floor may provide tension at a significant portion of the bag, between the portions of the bag that are retained by the respective floor bag retainers. Advantageously, the positioning of the floor bag retainers at different corners of the floor may further reduce bunching of the bag and increase an un-bunched volume of the bag.

Preferably, the pair of floor bag retainers are located proximate a first back corner and a second back corner, respectively.

In accordance with a third aspect of the present invention, there is provided a method of assembling a container of the second aspect of the present invention, comprising: preparing at least one bag retainer of the first aspect of the present invention; and attaching the at least one bag retainer to respective locations of the bag-retaining surface.

In some embodiments, preparing the at least one bag retainer comprises removing the adhesive backing.

It will be appreciated that any features described herein as being suitable for incorporation into one or more aspects or embodiments of the present invention are intended to be generalizable across any and all aspects and embodiments of the present invention. Other aspects of the present invention can be understood by those skilled in the art in light of the description, the claims, and the drawings of the present invention. The foregoing general description and the following detailed description are exemplary and explanatory only and are not restrictive of the claims.

### BRIEF DESCRIPTION OF THE DRAWINGS

The invention will now be described by way of example only with reference to the following Figures in which:

FIG. 1 shows a frontal view of a container in accordance with a first aspect of the present disclosure;

FIG. 2 shows a closer frontal view of a bag-retaining surface of the container of FIG. 1;

FIG. 3 shows a frontal view of a side of the bag-retaining surface of the container of FIG. 1;

FIG. 4a shows a perspective view of an upper side of a bag retainer used in the container of FIG. 1; and

FIG. 4b shows a perspective view of a lower side of the bag retainer of FIG. 4a.

### DETAILED DESCRIPTION

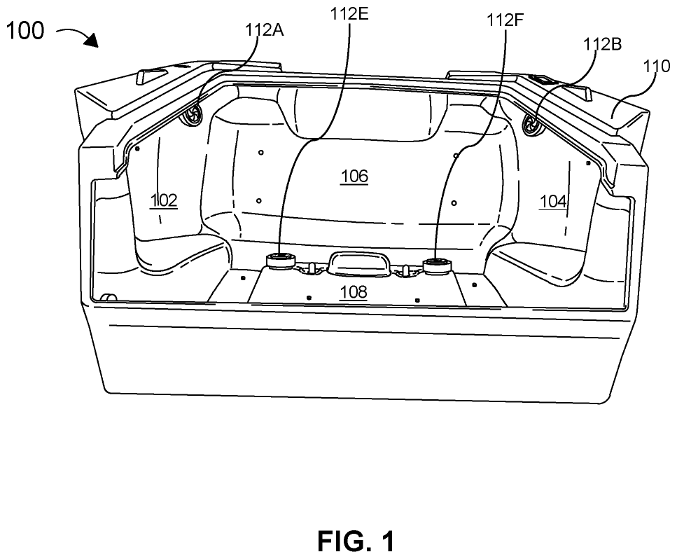

FIG. 1 shows a frontal view of a bin or container 100. The container 100 is configured to enable disposal of waste, such as hazardous dust, in a safe manner.

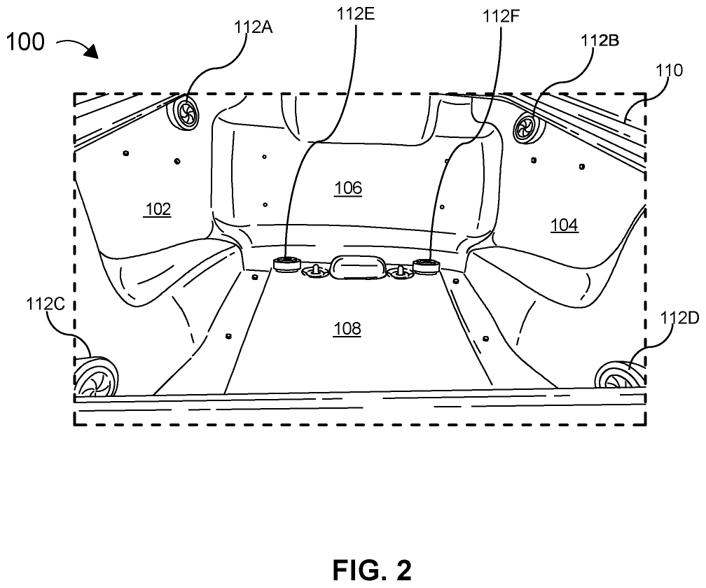

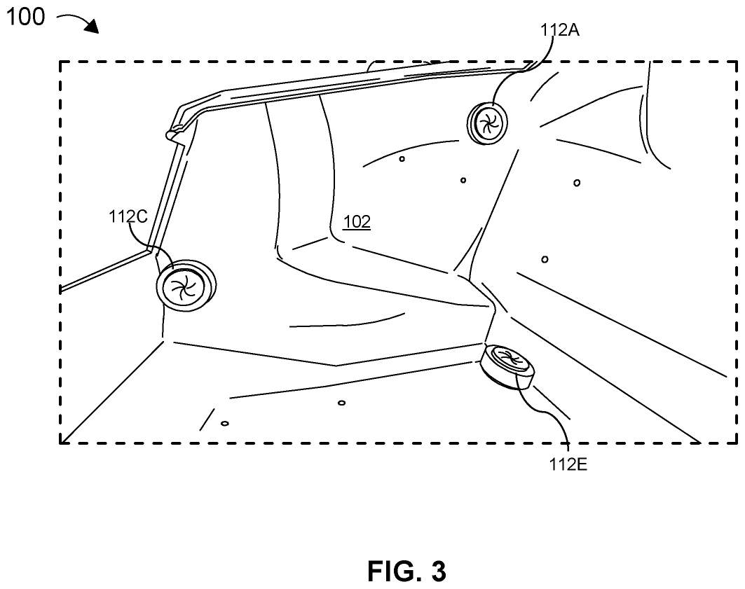

The container 100 comprises: container walls 102, 104, 106 and a container floor 108 forming a bag-retaining surface, the container walls 102, 104, 106 also forming a rim 110; and at least one bag retainer 112 attached to the bag-retaining surface, each bag retainer 112 being configured to retain a respective portion of a bag (not shown). FIG. 2 shows a closer frontal view of the bag-retaining surface of the container 100. FIG. 3 shows a frontal view of side wall 102 of the container 100.

The bag-retaining surface is a surface of the container 100 on which the bag is to be fitted or lined. In other words, the bag-retaining surface is a surface of the container 100 adapted to be at least partially covered by the bag in use. Ideally, the bag at least partially conforms to the shape of the bag-retaining surface to maximise intake and accommodation of waste. That is, the bag should have a minimum amount of bunching of different portions of the bag. The bag retainer 112 facilitates this shape matching, as is discussed further below.

The rim 110 is a portion of the container 100 formed by the container walls 102, 104, 106, over which an opening of the bag may be folded in use. As can be seen in FIGS. 1 to 3, the rim is formed by upper and side edges of side walls 102, 104. The rim 110 comprises a lip over which the bag can be folded. A bag is preferably selected that is dimensioned such that a perimeter of an opening of the bag is foldable over the whole of the rim 110, although it is conceivable that the opening of the bag could fold over a portion of the rim 110. For example, the opening of the bag may fold over upper edges of side walls 102, 104 such that a side of the bag fills a space between the side edges of side walls 102, 104.

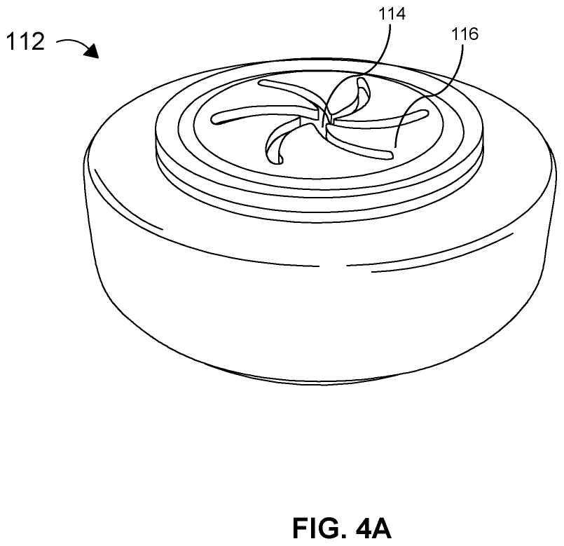

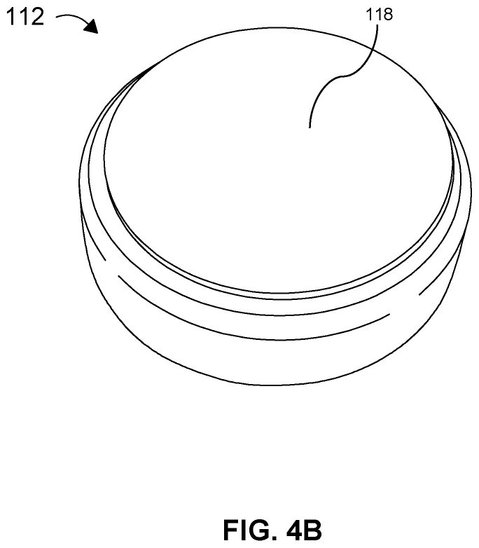

FIG. 4a shows a perspective view of an upper side of a bag retainer 112. FIG. 4b shows a perspective view of a lower side of the bag retainer 112.

The bag retainer 112 comprises a cavity having a bag-receiving aperture 114 on the upper side. The bag-receiving aperture 114 is configured to receive the respective portion of the bag. The bag retainer 112 also comprises resiliently flexible tabs 116 attached to and at least partially occluding a rim of the bag-receiving aperture 114. The tabs 116 are shaped to allow passage of the portion of the bag into the cavity, whilst resisting passage of the portion of the bag out of the cavity. In this way, the bag retainer 112 receives and retains the respective portion of the bag by allowing the portion of the bag to enter the cavity and resisting removal of the portion of the bag from the cavity. It is noted that the tabs do not completely prevent passage of the portion of the bag out of the cavity, such that the bag can be removed for further disposal of waste, for example when the bag has been used to receive waste from a sweeper.

The bag retainer 112 is detachable from the bag-retaining surface of the container 100. In the present example shown on FIG. 4b, the bag retainer 112 is detachable by means of an adhesive backing 118. The adhesive backing 118 comprises a removable sheet to protect an adhesive surface of the adhesive backing 118 when not in use. The removable sheet can be removed from the adhesive surface prior to attaching the bag retainer 112 to the bag-retaining surface. The adhesive surface comprises a pressure-sensitive adhesive.

In alternative embodiments, the bag retainer 112 is detachable by other means. For example, the container 100 may comprise bag retainer receivers (not shown) that are built into the bag-retaining surface. The bag retainers 112 can mechanically connect to the bag retainer receivers to hold the bag retainer in place. The bag retainer receivers can be located at pre-determined positions or may themselves be detachable and repositioned. Using bag retainer receivers may provide a means for assuring that bag retainers 112 are positioned at an appropriate location.

In further alternative embodiments, the bag retainer 112 is mechanically fixed to the bag-retaining surface. For example, the bag retainer 112 is affixed to the bag-retaining surface via a screw or bolt.

This detachability of the bag retainer 112 provides a means for re-arranging the positioning of bag retainer 112 on the bag-retaining surface if desired. In particular, the bag retainer 112 may be a distinct component from the container 100, and the detachability allows the bag retainer 112 to be attached at an appropriate position on the container 100.

In the illustrated embodiment of FIGS. 1 to 3, the at least one bag retainer 112 comprises a first pair of bag retainers 112A, 112B positioned on opposing side walls 102, 104 of the container 100. The first pair of bag retainers 112A, 112B are positioned at opposing positions on opposing side walls 102, 104 of the container 100. In particular, the first pair of bag retainers 112A, 112B are positioned proximate a first corner of respective side walls 102, 104. The first corner is an upper back corner of respective side walls 102, 104. In particular, bag retainer 112A is positioned proximate the upper back or rear corner of side wall 102 and bag retainer 112B is positioned proximate the upper back or rear corner of side wall 104. This location of bag retainers 112A, 112B maximises bag capacity and minimises loose portions of the bag billowing out in the direction of a vacuum during use.

The at least one bag retainer also comprises a second pair of bag retainers 112C, 112D positioned on opposing side walls 102, 104 of the container 100 at different positions to the first pair of bag retainers 112A, 112B. The second pair of bag retainers 112C, 112D are positioned proximate a second corner of respective side walls 102, 104. The second corner is a lower front corner of respective side walls 102, 104. In particular, bag retainer 112C is positioned proximate the lower front corner of side wall 102 and bag retainer 112D is positioned proximate the lower front corner of side wall 104. This location of bag retainers 112C, 112D also maximises bag capacity and minimises loose portions of the bag billowing out in the direction of a vacuum during use.

The at least one bag retainer 112 comprises at least one floor bag retainer 112E, 112F. The at least one floor bag retainer 112E, 112F comprises a pair of floor bag retainers 112E, 112F located proximate different corners of the container floor 108. In particular, bag retainer 112E is located proximate a first back corner of the container floor 108, and the bag retainer 112F is located proximate a second back corner of the container floor 108. This location of bag retainers 112E, 112F also maximises bag capacity and minimises loose portions of the bag billowing out in the direction of a vacuum during use.

This distribution of bag retainers 112 keeps and urges the bag in an intended shape during use. In particular, since the bag retainers 112 retain respective portions of the bag, these portions remain in the same position during use, and as such the bag itself also retains generally the same shape during use, rather than bunching or folding. Retaining the shape during use maximises the capturing area of the bag because bunching of the bag at the opening is minimised.

An advantage with placing the bag retainers in these positions may be that the amount of loose bag material may be reduced, thus reducing an amount of bag that may billow out, for example under vacuum pressure. Thus, the opening of the container may be maximally utilized, and a volume of the container may be maximally utilized.

Whilst the embodiment of FIG. 1 shows six bag retainers 112, it will be appreciated that a different number of bag retainers 112 may be used. Furthermore, a different positioning of the bag retainers 112 may be used.

To assemble the device, the bag retainers 112 are prepared. For example, to prepare the bag retainers 112 having an adhesive backing 118, the removable sheet is removed such that the bag retainers 112 are ready for attachment to the container 100. The bag retainers 112 are attached to the container 100 at the locations discussed above in relation to FIGS. 1 to 3. The container 100 is therefore ready for use. Respective portions of a bag are inserted into respective bag retainers 112, and the opening of the bag is folded over the rim 110. The container 100 with the bag attached can then be used with a sweeper machine. After use with the sweeper machine, the bag can be unfolded from the rim 110 and a cable tie or similar is used to close an opening of the bag. The bag is subsequently removed by applying a pulling force to each of the portions of the bag retained by the bag retainers so as to remove said portions. The bag can then be disposed of safely.

The description provided herein may be directed to specific implementations. It should be understood that the discussion provided herein is provided for the purpose of enabling a person with ordinary skill in the art to make and use any subject matter defined herein by the subject matter of the claims.

It should be intended that the subject matter of the claims not be limited to the implementations and illustrations provided herein, but include modified forms of those implementations including portions of implementations and combinations of elements of different implementations in accordance with the claims. It should be appreciated that in the development of any such implementation, as in any engineering or design project, numerous implementation-specific decisions should be made to achieve a developers' specific goals, such as compliance with system-related and business related constraints, which may vary from one implementation to another. Moreover, it should be appreciated that such a development effort may be complex and time consuming, but would nevertheless be a routine undertaking of design, fabrication, and manufacture for those of ordinary skill having benefit of this invention.

Reference has been made in detail to various implementations, examples of which are illustrated in the accompanying drawings and figures. In the detailed description, numerous specific details are set forth to provide a thorough understanding of the invention provided herein. However, the invention provided herein may be practiced without these specific details. In some other instances, well-known methods, procedures, components, circuits, and networks have not been described in detail so as not to unnecessarily obscure details of the embodiments.

It should also be understood that, although the terms first, second, etc. may be used herein to describe various elements, these elements should not be limited by these terms. These terms are only used to distinguish one element from another. For example, a first element could be termed a second element, and, similarly, a second element could be termed a first element. The first element and the second element are both elements, respectively, but they are not to be considered the same element.

The terminology used in the description of the invention provided herein is for the purpose of describing particular implementations and is not intended to limit the invention provided herein. As used in the description of the invention provided herein and appended claims, the singular forms “a,” “an,” and “the” are intended to include the plural forms as well, unless the context clearly indicates otherwise. The term “and/or” as used herein refers to and encompasses any and all possible combinations of one or more of the associated listed items. The terms “includes,” “including,” “comprises,” and/or “comprising,” when used in this specification, specify a presence of stated features, integers, steps, operations, elements, and/or components, but do not preclude the presence or addition of one or more other features, integers, steps, operations, elements, components and/or groups thereof.

While the foregoing is directed to implementations of various techniques described herein, other and further implementations may be devised in accordance with the invention herein, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A bag retainer for attachment to a bag-retaining surface of a container, the bag retainer comprising:
a cavity having a bag-receiving aperture configured to receive a respective portion of a bag.

2. The bag retainer of claim 1, comprising a resiliently flexible portion attached to a rim of the bag-receiving aperture.

3. The bag retainer of claim 2, wherein the resiliently flexible portion comprises one or more resiliently flexible tabs.

4. The bag retainer of claim 1, comprising an adhesive backing.

5. A container comprising:
container walls and a container floor forming a bag-retaining surface, the container walls also forming a rim; and
at least one bag retainer attached to the bag-retaining surface, each bag retainer being configured to retain a respective portion of a bag.

6. The container of claim 5, wherein the at least one bag retainer each comprises a cavity having a bag-receiving aperture configured to receive the respective portion of the bag.

7. The container of claim 6, wherein the at least one bag retainer each comprises a resiliently flexible portion attached to a rim of the bag-receiving aperture.

8. The container of claim 7, wherein the resiliently flexible portion comprises one or more resiliently flexible tabs.

9. The container of claim 5, wherein the at least one bag retainer is detachable from the bag-retaining surface of the container.

10. The container of claim 9, wherein the at least one bag retainer comprises an adhesive backing.

11. The container of claim 5, wherein the container walls comprise:
a first side wall;
a second side wall opposing the first side wall; and
a back wall connecting the first and second side walls.

12. The container of claim 11, wherein the at least one bag retainer comprises a first pair of bag retainers positioned on opposing side walls of the container.

13. The container of claim 12, wherein the at least one bag retainer also comprises a second pair of bag retainers positioned on opposing side walls of the container at different positions to the first pair of bag retainers.

14. The container of claim 13, wherein the first pair of bag retainers are positioned proximate a first corner of the respective side walls and the second pair of bag retainers are positioned proximate a second corner of the respective side walls.

15. The container of claim 14, wherein the first corner is an upper back corner, and the second corner is a lower front corner.

16. The container of claim 5, wherein the at least one bag retainer comprises at least one floor bag retainer.

17. The container of claim 16, wherein the at least one floor bag retainer comprises a pair of floor bag retainers located proximate different corners of the container floor.

18. The container of claim 17, wherein the pair of floor bag retainers are located proximate a first back corner and a second back corner, respectively.

19. A method of assembling a container comprising:
preparing at least one bag retainer comprising a cavity having a bag-receiving aperture configured to receive a respective portion of a bag; and
attaching the at least one bag retainer to respective locations of the bag-retaining surface;
wherein the container comprises:
container walls and a container floor forming a bag-retaining surface, the container walls also forming a rim; and
at least one bag retainer attached to the bag-retaining surface, each bag retainer being configured to retain a respective portion of a bag.

20. The method of claim 19, wherein preparing the at least one bag retainer comprises removing the adhesive backing.
